(19) United States
(12) Patent Application Publication
(10) Pub. No.: US 2007/0282520 A1
(43) Pub. Date: Dec. 6, 2007

(54) Systems and Methods for Affecting a Performance Characteristic of Vehicles Using Data Distribution

(76) Inventors: Ryan K. Cradick, Rochester, MN (US); Zachary A. Garbow, Rochester, MN (US); Kevin G. Paterson, San Antonio, TX (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/421,799

(22) Filed: Jun. 2, 2006

(51) Int. Cl. G06F 19/00

(52) U.S. Cl. 701/123; 701/22

(57) ABSTRACT

The present invention provides methods, apparatus, and systems for improving the fuel economy of an automobile. An automobile may be configured to receive data relating to a path traversed by the automobile from a server or from other automobiles traveling the path. The path data may indicate one or more road conditions such as traffic patterns, slopes, and the like. In response to receiving the path data, the automobile may automatically adjust the contribution of one or more components of the automobile configured to set the automobile in motion, to conserve fuel or otherwise improve some other performance characteristic of the automobile. For example, the number of cylinders used to operate the vehicle and the electric motor assistance ratios may be adjusted.

### BACKGROUND OF THE INVENTION

1. Field of the Invention

The present invention generally relates to automobiles, and more specifically to software algorithms to improve the fuel efficiency of automobiles.

2. Description of the Related Art

The rising gas prices in recent years have become a major concern not only for businesses, but also for average consumers. Not only have consumers seen increasing gas prices at the pump, but even every day goods and services purchased by the average consumer have become more expensive with the rising costs of fuel. With growing concerns over such steadily increasing gas prices combined with other significant concerns such as environmental conservation, dependence on foreign fuel, and the like, average consumers have started to turn to vehicles that utilize innovative solutions to improve fuel economy. For example, hybrid vehicles, and vehicles with variable cylinder management have provided significant improvement in fuel economy.

A hybrid vehicle is powered by multiple propulsion systems, for example, an electric motor and an internal combustion engine. The internal combustion engine may utilize petroleum based fuels such as gasoline, diesel, and the like, to provide propulsion. The electric motor, on the other hand may be powered by rechargeable batteries. The electric motor may be configured to assist the internal combustion engine in a predefined set of circumstances, for example, during acceleration, passing other vehicles, hill climbing, etc., where the internal combustion engine may be inefficient. By allowing an electric motor to function in conjunction with a fuel based motor higher fuel efficiency may be achieved. Higher fuel efficiency could reduce the total amount of fuel consumed by an automobile, thereby allowing consumers to cut down significantly on fuel costs.

Variable cylinder management involves activating and deactivating cylinders as needed to improve fuel economy. For example, during periods of steady speed, fewer cylinders may be utilized to reduce fuel consumption.

One problem with the prior art is that the contribution of the various components involved in operating the vehicle do not depend on imminent road conditions. Furthermore, current software algorithms adjust the roles of different components only after a particular road condition is encountered. For example, the contribution of an electric motor may be increased when the automobile begins to navigate a hill. However, because the roles of components are adjusted only after the hill is encountered, a significant portion of the hill may be traveled on before a fuel efficient configuration is achieved.

If the roles of components are proactively adjusted before the road condition is encountered, the entire portion of the road condition may be navigated with a configuration of components that maximizes performance of the vehicle. For example, by increasing the contribution of the electric motor prior to encountering the hill, the entire portion of the hill may be navigated using increased contribution from the electric motor.

Accordingly, what is needed are methods, systems and apparatus that allow an automobile to anticipate upcoming road conditions and adjust the contribution of components that propel the automobile to improve the fuel economy of the automobile.

### SUMMARY OF THE INVENTION

The present invention generally relates to automobiles, and more specifically to software algorithms to improve the fuel efficiency of automobiles.

One embodiment of the invention provides a method for improving fuel economy of a vehicle. The method generally comprises sending a request for data related to the condition of a path traveled by the vehicle by a first computer on-board the vehicle to a second computer, receiving, by the first computer, the requested data related to the condition of the path sent by the second computer, and in response to receiving the data, adjusting the contribution of one or more components of the vehicle configured to set the vehicle in motion based on the received data.

Another embodiment of the invention provides a method for improving fuel economy of a hybrid vehicle comprising an internal combustion engine and an electric motor. The method generally comprises sending a request for data related to the condition of a path traveled by the hybrid vehicle by a first computer on-board the vehicle to a second computer, receiving, by the first computer, the requested data related to the condition of the path sent by the second computer, and in response to receiving the data, adjusting the contribution of the internal combustion engine and the electric motor to the motion of the hybrid vehicle based on the received data.

Yet another embodiment of the invention provides a computer readable storage medium containing a program which, when executed, performs operations for improving fuel economy of a vehicle. The operations generally comprise sending a request for data related to the condition of a path traveled by the vehicle by a first computer on-board the vehicle to a second computer, receiving, by the first computer, the requested data related to the condition of the path sent by the second computer, and in response to receiving the data, adjusting the contribution of one or more components of the vehicle configured to set the vehicle in motion based on the received data.

A further embodiment of the invention provides a system comprising a first computer on-board a vehicle and at least one second computer configured to retrieve data related to a path traveled by the vehicle. The first computer generally comprises memory containing an application for improving the fuel economy of the vehicle, and a processor communicably connected to the memory. The processor, when executing the application is generally configured to send a request for data related to the condition of the path traveled by the vehicle to the second computer, receive the requested data related to the condition of the path sent by the second computer, and in response to receiving the data, adjust the contribution of one or more components of the vehicle configured to set the vehicle in motion based on the received data.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates the transfer of path data to an automobile, according to one embodiment of the invention.

FIG. 2 is an illustration of an exemplary system, according to one embodiment of the invention.

FIG. 3 is a flow diagram of exemplary operations performed to manage the usage of cylinders, according to one embodiment of the invention.

FIG. 4 is a flow diagram of exemplary operations performed to adjust the electric motor assistance ratio, according to one embodiment of the invention.

FIG. 5 is a flow diagram of exemplary operations performed to manage the usage of the electric motor, according to one embodiment of the invention.

### DETAILED DESCRIPTION OF THE PREFERRED EMBODIMENTS

The present invention provides methods, apparatus, and systems for improving the fuel economy of an automobile. An automobile may be configured to receive data relating to a path traversed by the automobile from a server or from other automobiles traveling the path. The path data may indicate one or more road conditions such as traffic patterns, slopes, and the like. In response to receiving the path data, the automobile may automatically adjust the contribution of one or more components of the automobile configured to set the automobile in motion, to conserve fuel or otherwise improve some other performance characteristic of the automobile. For example, the number of cylinders used to operate the vehicle and the electric motor assistance ratios may be adjusted.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

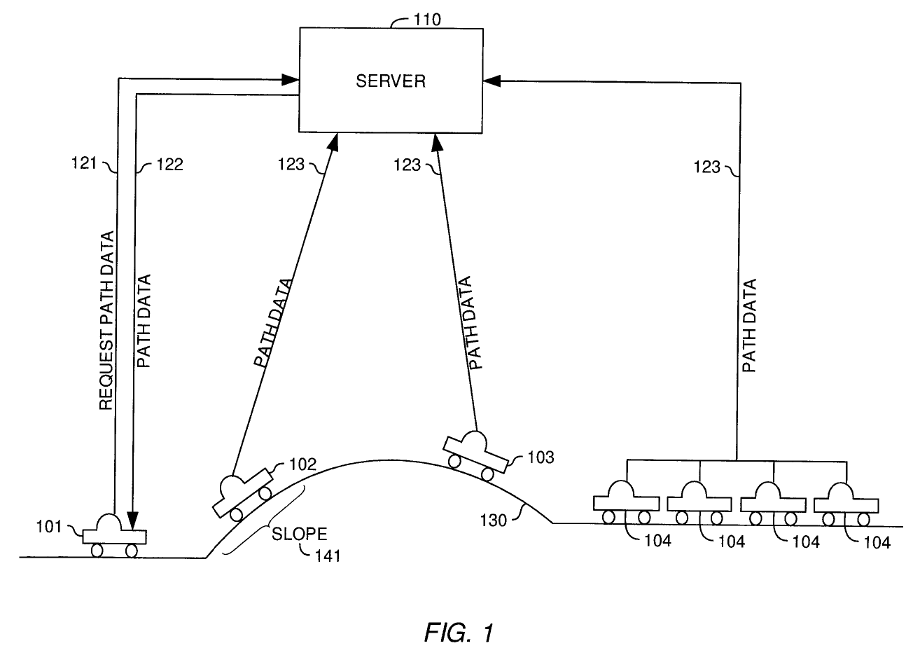

FIG. 1 is a diagram illustrating the transfer of path data to an automobile 101 traveling on a path 130. Illustrative path data includes braking and acceleration metrics, gradient/slope of the road, traffic patterns, driving speeds, speed limits, fuel efficiency, and the like. As illustrated, automobile 101 may send requests for path data 121 to a server 110. Server 110 may be configured to provide data related to the path 122 in response to receiving requests 121. In some embodiments path data 122 may be a compiled representation of path data 123 collected from other vehicles that are traveling the path, or have recently traveled the path.

For example, as illustrated in FIG. 1, automobiles 102, 103, and 104 may send path data to server 110. Automobile 102, for example, may send data to server 110 indicating that it is traveling on an upward slope. Automobile 103 may send data to server 110 indicating that it is traveling on a downward slope. Automobiles 104 may send server 110 path data indicating heavy traffic conditions. In some embodiments, path data 122 may be the average of path data collected from one or more vehicles. For example, path data 122 may include an average of path data collected from vehicles 104 that are associated with the same or similar road condition (a traffic jam in FIG. 1). Server 110 may be configured to collect path data from each of automobiles 104 and compute the average of the path data 122 that is relayed to automobile 101.

In response to receiving the path data, automobile 101 may adjust the contribution of components of the automobile that are configured to set the automobile in motion (hereinafter referred to as “the components”). Such adjustment may be configured to maximize fuel efficiency. For example, in one embodiment, automobile 101 may be a hybrid automobile. In response to determining an upcoming upward slope 141, automobile 101 may increase the amount of assistance provided by the electric motor prior to encountering the slope. The amount of assistance provided by the electric motor may be increased because the internal combustion engine may be inefficient while traveling on an upward slope. Therefore, fuel may be saved and fuel economy of the automobile improved.

Increasing the assistance provided by the electric motor prior to encountering the slope may allow automobile 101 to navigate the entire portion of the slope with greater electric motor assistance. Conventional hybrid vehicles, on the other hand, increase electric motor assistance after the slope is encountered, during which time a significant portion of the slope may be traveled. Therefore, embodiments of the invention increase fuel economy by adjusting contribution of the components of the automobile that are configured to operate the automobile based on anticipated road conditions before the road conditions are encountered.

In some embodiments, if server 110 cannot be reached by automobile 101, for example, if server 110 is out of range, requests 121 may be sent directly to the other vehicles traveling the path. For example, the requests 121 may be sent from automobile 101 to automobiles 102, 103, and 104. Automobiles 102, 103, and 104 may send path data directly to automobile 101 in response to receiving a request 121. Automobile 101 may compile the responses received from the automobiles and adjust the contribution of the components of automobile 101 based on the compiled data. In some embodiments, if server 110 is out of range and/or unavailable path data 123 may be stored locally in memory included in an automobile. The path data may be sent to server 110 when it becomes available.

Embodiments of the invention are described herein with reference to automobiles for convenience of illustration. One skilled in the art will recognize however, that the embodiments are not limited to automobiles only. Rather, the invention may apply to any type of vehicle, including motorcycles, boats, and the like.

One embodiment of the invention is implemented as a program product for use with a computer system such as, for example, system 200 described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

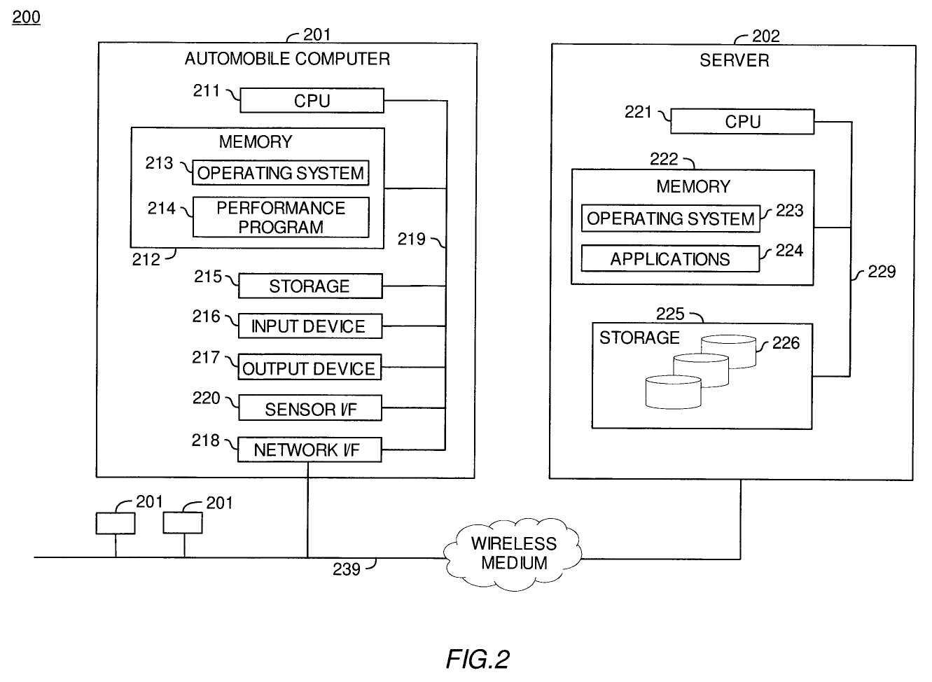

FIG. 2 depicts a block diagram of a networked system 200 in which embodiments of the present invention may be implemented. In general, the networked system 200 includes an automobile computer 201 (three such automobile computers 201 are shown) and at least one server 202. The automobile computers 201 and server 202 may be part of a network 239. In general, the network 239 may be a local area network (LAN), a wide area network (WAN), and/or a Metropolitan area Network (MAN). The communications between the server and automobile computers described above may be performed over a wireless medium. The medium may be radio, switched circuit cellular, Cellular Digital Packet Data (CPDP), Personal Communication Services (PCS), communication satellite, or some combination of these.

Each automobile computer 201 may be a mobile unit that resides within an automobile. The automobile computer 201 includes a Central Processing Unit (CPU) 211 connected via a bus 219 to a memory 212, storage 215, an input device 216, an output device 217, a network interface device 218, and a sensor interface 220. The input device 216 can be any device to give input to the automobile computer 201. For example, a keyboard, keypad, light-pen, touch-screen, track-ball, or speech recognition unit, audio/video player, and the like could be used. The output device 217 can be any device to give output to the user, e.g., any conventional display screen. Although shown separately from the input device 216, the output device 217 and input device 216 could be combined. For example, a display screen with an integrated touch-screen, a display with an integrated keyboard, or a speech recognition unit combined with a text speech converter could be used.

The network interface device 218 may be any entry/exit device configured to allow network communications between the automobile computers 201 and server 202 via the network 239. For example, the network interface device 218 may include a transmitter and receiver to exchange wireless communications with server 202 and other automobile computers 201. In one embodiment, network interface device 218 may include a Global Positioning System (GPS) receiver configured to receive data such as automobile location and other data such as path data. The network interface device may be further configured to send automobile data including automobile performance metrics, road conditions, and the like, to server 202.

Storage 215 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 212 and storage 215 could be part of one virtual address space spanning multiple primary and secondary storage devices.

The memory 212 is preferably a random access memory such as a Dynamic Random Access Memory (DRAM) sufficiently large to hold the necessary programming and data structures of the invention. While memory 212 is shown as a single entity, it should be understood that memory 212 may in fact comprise a plurality of modules, and that memory 212 may exist at multiple levels, from high speed registers and caches to lower speed but larger DRAM chips.

Illustratively, the memory 212 contains an operating system 213. Any operating system supporting the functions disclosed herein may be used. The memory 212 is also shown containing a performance program 214 that, when executed by CPU 211, provides support for adjusting the contribution of the components of an automobile to conserve fuel. Performance program 214, for example, may initiate requests for path data. The performance program 214 may then adjust the contribution of the components based on the responses to the requests. In some embodiments, executing performance program 214 may include receiving path data from automobiles traveling a path and compiling the data received from multiple automobiles.

Sensor interface 220 may be configured to receive data from one or more sensors of the automobile containing the automobile computer. The sensors may collect data from the automobile itself and from the environment surrounding the automobile. The data collected by the sensors may be passed on to the sensor interface through serial or USB connections, for example. The sensor data may include atmospheric/weather conditions, road condition, neighboring vehicle proximity, vehicle orientation, vehicle differential speed, and the like.

In some embodiments, sensor data received through the sensor interface may be stored within the automobile computer 201 for later use. For example, the sensor data may be stored in storage 215. The stored data may be used to adjust the contribution of the components of the automobile at a later time. For example, the sensor data related to a particular path may be used to determine the contribution of the components the next time the path is traversed.

The sensor data may also be sent to the server 202 through network interface 218. The sensor data may be sent at regular intervals. For example, sensor data may be sampled every minute and the data may be sent to the server. In other embodiments, sensor data may be sent to the server in response to detecting a particular event or condition. For example, sensor data may be sent to the server in response to detecting a slope on the road.

The server 202 may be physically arranged in a manner similar to the client computer 201. Accordingly, the server 202 is shown generally comprising a CPU 221, a memory 222, and a storage device 225, coupled to one another by a bus 229. Memory 222 may be a random access memory sufficiently large to hold the necessary programming and data structures that are located on the server 202. The server 202 is generally under the control of an operating system 223 shown residing in memory 222. Any operating system capable of supporting the functions described herein may be used.

The memory 222 further includes one or more applications 224. Applications 224 may include any necessary software for receiving and processing requests and data from an automobile computer 201. For example, Applications 224 may receive data from one or more automobiles and store the data in a database 226. Applications 224 may be further configured to compile the data and distribute the data among one or more requesting automobiles. The software may comprise a plurality of instructions that are resident at various times in various memory and storage devices in the computer system 200. Exemplary software includes query parsers and optimizers and query engines. When read and executed by one or more processors 221 in the server 202, Applications 224 may cause the computer system 200 to perform the steps necessary to execute steps or elements embodying the various aspects of the invention. The applications 224 (and more generally, any requesting entity, including the operating system 223) is configured to issue queries against a database 226 (shown in storage 225).

The database 226 is representative of any collection of data regardless of the particular physical representation. By way of illustration, the database 226 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data. Queries issued by automobile computer 201 may be executed against database 226. Appropriate query results may then be returned to automobile computer 201. Although only one database is shown, it is contemplated that any number of databases may be provided.

### Variable Cylinder Management

In one embodiment of the invention, the number of cylinders utilized to operate the automobile may be adjusted based on upcoming path conditions. A cylinder is the central working part of an internal combustion engine. Multiple cylinders may be arranged side by side in a bank called the engine block. Each cylinder may contain a piston. The combustion of fuel in the cylinder moves the piston up and down within the cylinder, which in turn sets the automobile in motion.

When multiple cylinders are available in the automobile, the ability to activate and deactivate the number of cylinders used may allow for the conservation of fuel. It may be necessary to utilize all cylinders during acceleration. For example, all cylinders may be necessary to provide enough power to climb a hill, pass other vehicles, etc. However, when the automobile is expected to travel flat roads, with sparse traffic, the automobile is likely to travel at a constant pace with little acceleration. In such situations, using all cylinders may wastep fuel because each cylinder may burn fuel without providing a significant contribution to the motion of the vehicle.

In a specific embodiment, an automobile may contain 6 cylinders. However, the automobile may operate on three cylinders or all six cylinders based on the upcoming path conditions. To deactivate cylinders, the valves of the cylinders may be prevented from opening. The closed valves may prevent fuel from entering the cylinder, thereby deactivating the cylinder.

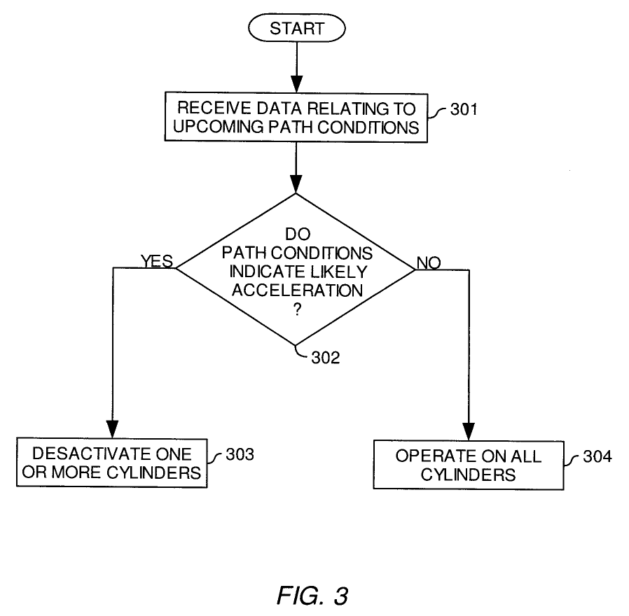

FIG. 3 is a flow diagram of exemplary operations performed by performance program 214 in an automobile to deactivate one or more cylinders in an automobile. The operations begin in step 301 by receiving data related to an upcoming path conditions. The data related to the path conditions may be received from a server, for example, server 202 in FIG. 2, or from one or more other automobiles traveling the path. In one embodiment, the automobile may be configured to issue requests for the data at regular intervals, which may be user configurable, or determined by the system. The path data may be received in response to such requests. In other embodiments, a server may send path data to the automobile at regular intervals even if no requests have been issued.

In step 302, performance program 214 may determine whether the upcoming path conditions indicate that the automobile is likely to accelerate. The likelihood of acceleration may indicate a need for greater power to operate the vehicle. For example, performance program 214 may determine the power and torque that may be necessary to navigate upcoming path conditions. Performance program 214 may also determine whether the upcoming path conditions indicate a likelihood that the automobile will travel at a constant speed. For example, the path data may indicate that the upcoming terrain is flat, that the speed limit along the path is constant, that traffic is light, etc. However, path conditions that show uneven terrain, heavy traffic conditions, acceleration of other vehicles along the path, and the like may indicate that acceleration is likely.

The automobile operator's current and/or past driving behavior may also be considered in determining whether acceleration is likely. For example, if the operator is an aggressive driver, acceleration may be more likely. On the other hand, if historic data shows that the driver tends to accelerate slowly, then acceleration may not be deemed likely.

If, in step 302, it is determined that the automobile is likely to travel at a constant speed, performance program 214 may deactivate one or more cylinders based on the path data to conserve fuel, in step 303. In one embodiment, the number of cylinders deactivated may depend on the speed of the automobile. Furthermore, performance program 214 may be configured to operate the automobile on at least a minimum number of cylinders. For example, performance program 214 may ensure that at least three cylinders are always active.

If, on the other hand, it is determined in step 302 that acceleration is likely in the path ahead, performance program 214 may configure the automobile to operate on all cylinders, in step 304. If the automobile is already operating on all cylinders the status quo may be maintained. However, if the automobile was operating on fewer than all cylinders, performance program 214 may activate the deactivated cylinders. In some embodiments, if the automobile was operating on fewer than all cylinders performance program 214 may activate one or more (but not all) additional cylinders based on the nature of the acceleration expected to be encountered.

### Adjusting Electric Motor Assist

In some embodiments, the automobile may be a hybrid automobile, and performance program 214 may be configured to adjust the electric motor assistance ratio based on upcoming path conditions. A hybrid vehicle may contain both an internal combustion engine and an electric motor powered by rechargeable batteries. The internal combustion engine may be powered by hydrocarbon based fuels such as gasoline, diesel, natural gas, and the like. However, the internal combustion engine may be inefficient for certain driving conditions such as hill climbing, accelerating, lower speed driving, and the like. The electric motor may provide greater assistance while navigating such driving conditions to conserve fuel.

Embodiments of the invention allow the electric motor assistance ratio to be adjusted proactively before the aforementioned driving conditions are encountered, thereby improving fuel economy further. The electric motor assistance ratio may indicate the ratio between of the contribution of the electric motor to the contribution of the internal combustion engine to the operation/motion of the automobile.

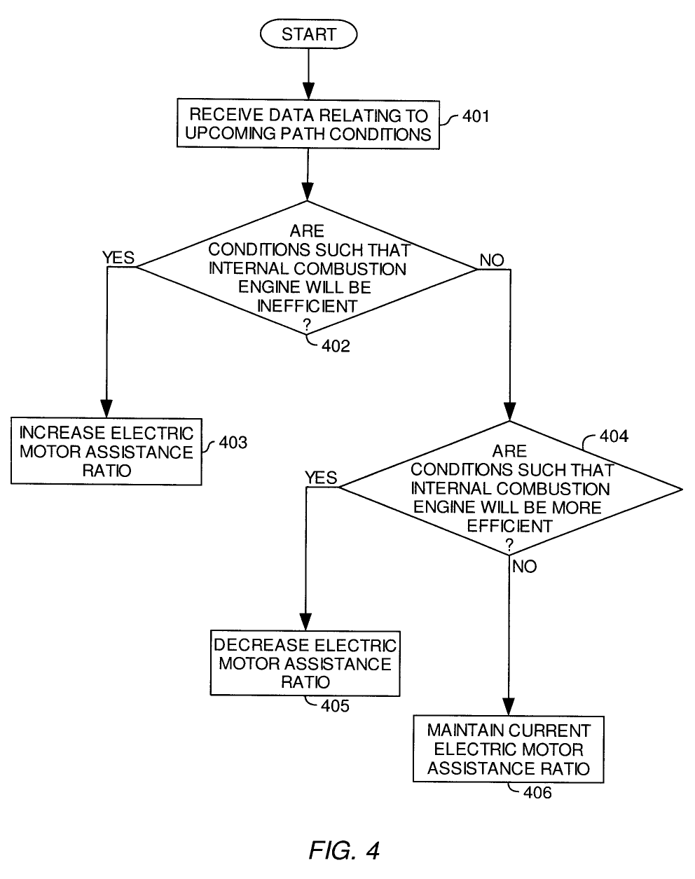

FIG. 4 is a flow diagram of exemplary operations performed by the performance program 214 to adjust the electric motor assist ratio. The operations begin in step 401 by receiving data related to an upcoming path condition. The data related to the path conditions may be received from a server, for example, server 202 in FIG. 2, or from one or more other automobiles traveling the path. In one embodiment, the automobile may be configured to issue requests for the data at regular intervals, which may be user configurable, or determined by the system. The path data may be received in response to such requests. In other embodiments, a server may send path data to the automobile at regular intervals even if no requests have been issued.

In step 402, performance program 214 may determine whether the upcoming path conditions indicate that the internal combustion engine will be inefficient to navigate the condition. For example, the path conditions may indicate an upcoming hill, slow moving automobile, lower speed limits, and the like. The internal combustion engine may be inefficient while navigating such conditions. Therefore, the electric motor assistance ratio may be increased, in step 403, to conserve fuel while navigating the upcoming road condition where the internal combustion engine will be inefficient. Increasing the electric motor assistance may involve increasing the contribution of the electric motor to the propulsion of the vehicle with respect to the contribution of the internal combustion engine.

If it is determined, in step 402, that the internal combustion engine will be inefficient to navigate the upcoming conditions, then the operation in step 404 may be performed. In step 404, if it is determined that the upcoming road conditions are such that the internal combustion engine will be more efficient to navigate the condition, then, in step 405, the electric motor assistance ratio may be decreased. Therefore, the contribution of the internal combustion engine to the propulsion of the automobile may be increased and the contribution of the electric motor may be decreased. For example, the path data may indicate that the upcoming road has a high speed limit and that there is no traffic. Therefore, the automobile may be expected to travel at high speeds where the internal combustion engine may be efficient. The electric motor assistance ratio may be decreased to allow the internal combustion engine to provide a larger contribution to the propulsion of the automobile.

If, on the other hand, it is determined in step 404 that that the internal combustion engine will not be more efficient, in step 406, the current electric motor assistance ratio may be maintained.

In one embodiment, the performance program may be configured to intelligently start or stop the internal combustion engine based on forecasted usage. For example, the automobile may be stuck in extremely heavy traffic conditions that extend for many miles. In such conditions the automobile may be expected to make only small, short-lived movements along the path. If such conditions are encountered, the performance program may be configured to operate the automobile on the electric motor only, even if a period of acceleration is encountered. Therefore, the fuel, which would have been used inefficiently by the internal combustion engine, will be saved.

In a hybrid automobile, it may be essential to recharge the batteries that power the electric motor in order to ensure that the electric motor assistance is available. To recharge batteries, the electric motor may apply resistance to the drive train, causing the wheels to slow down. The energy from the wheels may turn the motor, which may function as a generator, converting energy normally wasted during coasting and braking into electricity, which is stored in the battery until needed by the electric motor.

Embodiments of the invention may allow the adjustment of electric motor usage based on anticipated opportunities to recharge the batteries via regenerative braking, for example, during coasting, traveling downhill, stopping, etc. Therefore, the usage of the electric motor may be managed more effectively. For example, the path data may indicate the presence of a downward slope a few miles down the path. The downward slope may provide ample opportunity to recharge the batteries. Therefore, the contribution of the electric motor may be increased for the portion of the path leading up to the downward slope, thereby saving fuel.

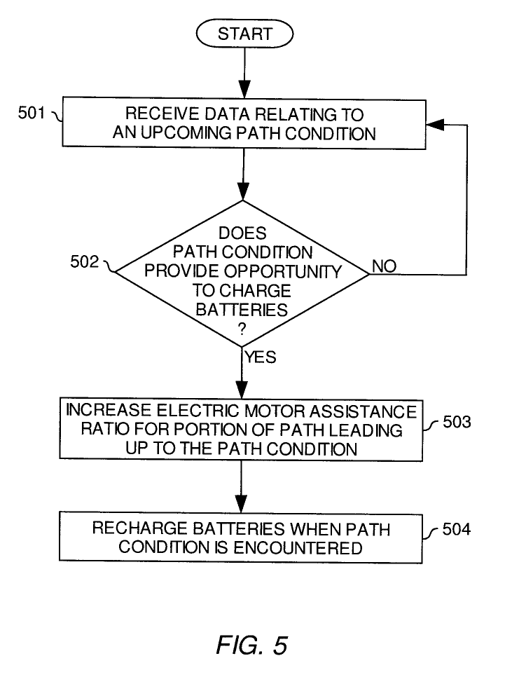

FIG. 5 is a flow diagram of exemplary operations performed by the performance program 214 to manage the use of the electric motor. The operations begin in step 501 by receiving data related to an upcoming path condition. The data related to the path conditions may be received from a server, for example, server 202 in FIG. 2, or from one or more other automobiles traveling the path. In one embodiment, the automobile may be configured to issue requests for the data at regular intervals, which may be user configurable, or determined by the system. The path data may be received in response to such requests. In other embodiments, a server may send path data to the automobile at regular intervals even if no requests have been issued.

In step 502, the performance program 214 may determine whether the path data indicates opportunities to recharge the batteries powering the electric motor. For example, the path data may indicate an upcoming downward slope, or a stop sign. If such opportunities to recharge the battery are indicated by the path data, performance program 214 may increase the motor assistance ratio in step 503 so that the electric motor is used more generously, thereby conserving fuel. In step 504, when the path condition is encountered, the batteries powering the electric motor may be recharged.

In some embodiments, performance program 214 may suggest an alternative path to the destination of the automobile based on the amount of energy available to the electric motor and the internal combustion engine. For example, the performance program may determine the amount of energy available to the electric motor based on current status of the batteries and opportunities to recharge the batteries. Performance program 214 may determine the amount of energy available to the internal combustion engine based on the available fuel. Performance program 214 may be further configured to select alternative paths to the destination of the automobile based on the availability of energy to propel the automobile, the road conditions along the path, expected usage of the components of the automobile, and the like, in order to maximize fuel efficiency.

In some embodiments, the path may be altered to maximize the batteries charge rate, if desired. For example, performance program 214 may select a path that offers the most opportunity to recharge batteries, thereby allowing the automobile to operate with a greater contribution from the electric motor.

In some embodiments, in addition to current path data, the performance program 214 may also be configured to adjust the contribution of components based on historic data stored in the automobile computer. For example, the automobile may store data related to frequently traveled path. The data may include road conditions, driver behavior, traffic patterns, speed limits, and the like. The contribution of the components may be optimized based on the historic data. For example, a driver may travel the same path to work every morning. The path may include one or more road conditions such as hills, stop lights and the like. Furthermore, the traffic patterns may be similar each morning that the driver travels the path. Therefore, performance program 214 may be able to predict path data based on historic data, and adjust the contribution of components accordingly to conserve fuel.

In one embodiment, performance program 214 may be configured to implement two or more strategies for adjusting the contribution of components for a given frequently traveled path, monitor the performance of the automobile for each strategy, and select the strategy that maximizes the performance of the automobile. For example, on a first day, performance program 214 may select a first electric motor assistance ratio while traveling the path, and store performance metrics, for example, fuel economy for the journey. On a second day, performance program 214 may select a second electric motor assistance ratio to travel the path and store the performance metrics for the journey on the second day. By comparing the performance metrics for each strategy, performance program 214 may select the strategy that maximizes performance based on the historic data.

While several methods of adjusting contribution of components are described above, one skilled in the art will appreciate that any combination of the methods may be used in conjunction to maximize the conservation of fuel or affect some other performance characteristics (e.g., limit the number of transitions between transmission gears). For example, a hybrid automobile may use any combination of variable cylinder management, adjustment of electric motor assistance, and historic data analysis to affect a desired performance characteristic.

One skilled in the art will also recognize that the path data received by an automobile may be filtered, wherein the filtering may be performed based on criteria relevant to the automobile and its intended path. For example, the automobile may request data for only current or surrounding areas. In some embodiments the data requested may be limited by the automobiles intended path, based on an onboard map or itinerary. In other embodiments, the data requested may be compiled only from data received from similar vehicles. The similarity of vehicles may be determined, for example, based on vehicle size, type, and the like. Illustrative vehicle categories may include compact cars, trucks, garbage trucks, emergency vehicles, etc.

### CONCLUSION

By allowing an automobile to automatically adjust the contribution of components configured to set the automobile in motion in response to anticipating upcoming path conditions, significant amounts of fuel may be conserved and the automobiles fuel economy increased, thereby resulting in significant savings to the automobile driver.

While the foregoing is directed to embodiments of the present invention, other and further embodiments of the invention may be devised without departing from the basic scope thereof, and the scope thereof is determined by the claims that follow.

What is claimed is:

1. A method for improving fuel economy of a vehicle, comprising:
sending a request for data related to the condition of a path traveled by the vehicle by a first computer on-board the vehicle to a second computer;
receiving, by the first computer, the requested data related to the condition of the path sent by the second computer; and
in response to receiving the data, adjusting the contribution of one or more components of the vehicle configured to set the vehicle in motion based on the received data.

2. The method of claim 1, wherein the two or more components comprise two or more cylinders of the vehicle and the adjusting comprises selecting the number of cylinders used to operate the vehicle.

3. The method of claim 2, wherein fewer cylinders are used to operate the vehicle if the vehicle is expected to travel at a relatively steady speed.

4. The method of claim 1, wherein the vehicle is a hybrid vehicle, wherein the two or more components comprise:
an internal combustion engine; and
an electric motor.

5. The method of claim 4, wherein the adjusting comprises any combination of:
adjusting the amount of assistance provided by the electric motor to operate the vehicle; and
starting or stopping the use of the internal combustion engine based on forecasted usage.

6. The method of claim 4, further comprising:
identifying path conditions that offer opportunities to charge batteries powering the electric motor based on the data related to the condition of the path and adjusting the contribution of the electric motor based on the identified opportunities; and
selecting an alternative path to elongate the distance that can be traveled by the vehicle based on available fuel for the internal combustion engine, power available to the electric motor, and the data related to the condition of the path.

7. The method of claim 1, further comprising:
receiving, by a server, the requests from the vehicle, wherein the server is the second computer; and
in response to receiving the request, providing, by the server to the vehicle, the data related to the condition of the path, wherein the data is the average of data received from one or more other vehicles traveling on the path.

8. The method of claim 1, further comprising receiving the requests from the vehicle by one or more other vehicles traveling the path and providing, by a computer associated with each of the one or more other vehicles to the vehicle, the data related the condition of the path, wherein
each of the computers associated with the one or more other vehicles is the second computer; and
the first computer is configured to compute an average for data received from the one or more other vehicles.

9. The method of claim 8, wherein the one or more other vehicles are of the same type as the vehicle.

10. The method of claim 1, further comprising, if the requested data is not received by the first computer, adjusting the contribution of the one or more components of the vehicle configured to set the vehicle in motion based on historic data related to the path stored in the first computer.

11. The method of claim 1, wherein the data related to the condition of the path comprises one or more of:
braking and acceleration metrics for vehicles traveling on the path;
gradients and slopes along the path;
traffic patterns along the path;
driving speeds along the path; and
speed limits along the path.

12. The method of claim 1, further comprising storing in the first computer the data related to the condition of the path each time the path is traveled and adjusting the contribution of the two or more components of the vehicle configured to set the vehicle in motion based on the stored data.

13. A method for improving fuel economy of a hybrid vehicle comprising an internal combustion engine and an electric motor, comprising:
sending a request for data related to the condition of a path traveled by the hybrid vehicle by a first computer on-board the vehicle to a second computer;
receiving, by the first computer, the requested data related to the condition of the path sent by the second computer; and
in response to receiving the data, adjusting the contribution of the internal combustion engine and the electric motor to the motion of the hybrid vehicle based on the received data.

14. The method of claim 13, further comprising, adjusting the contribution of two or more cylinders of the hybrid vehicle to the motion of the hybrid vehicle, wherein the adjusting comprises selecting the number of cylinders used to operate the automobile.

15. The method of claim 13, wherein the adjusting comprises any combination of:
adjusting the amount of assistance provided by the electric motor to operate the vehicle; and
starting or stopping the use of the internal combustion engine based on forecasted usage.

16. The method of claim 13, further comprising:
identifying path conditions that offer opportunities to charge batteries powering the electric motor based on the data related to the condition of the path and adjusting the contribution of the electric motor based on the identified opportunities; and
selecting an alternative path to elongate the distance that can be traveled by the vehicle based on available fuel for the internal combustion engine, power available to the electric motor, and the data related to the condition of the path.

17. A computer readable storage medium containing a program which, when executed, performs operations for improving fuel economy of a vehicle, comprising:
sending a request for data related to the condition of a path traveled by the vehicle by a first computer on-board the vehicle to a second computer;
receiving, by the first computer, the requested data related to the condition of the path sent by the second computer; and
in response to receiving the data, adjusting the contribution of one or more components of the vehicle configured to set the vehicle in motion based on the received data.

18. The computer readable storage medium of claim 17, wherein the two or more components comprise two or more cylinders of the vehicle and the adjusting comprises selecting the number of cylinders used to operate the vehicle.

19. The computer readable storage medium of claim 17, wherein the vehicle is a hybrid vehicle comprising an internal combustion engine and an electric motor, and wherein the adjusting comprises:
adjusting the amount of assistance provided by the electric motor to operate the vehicle; and
starting or stopping the use of the internal combustion engine based on forecasted usage.

20. The computer readable storage medium of claim 19, wherein the operations further comprise:
identifying path conditions that offer opportunities to charge batteries powering the electric motor based on the data related to the condition of the path and adjusting the contribution of the electric motor based on the identified opportunities; and
selecting an alternative path to elongate the distance that can be traveled by the vehicle based on available fuel for the internal combustion engine, power available to the electric motor, and the data related to the condition of the path.

21. A system, comprising:
a first computer on-board a vehicle, comprising:
memory containing an application for improving the fuel economy of the vehicle; and
a processor communicably connected to the memory; and
at least one second computer configured to retrieve data related to a path traveled by the vehicle,
wherein the processor, when executing the application is configured to:
send a request for data related to the condition of the path traveled by the vehicle to the second computer;
receive the requested data related to the condition of the path sent by the second computer; and
in response to receiving the data, adjust the contribution of one or more components of the vehicle configured to set the vehicle in motion based on the received data.

22. The system of claim 21, wherein the two or more components comprise two or more cylinders of the vehicle and the processor is configured to select the number of cylinders used to operate the vehicle based on the received data.

23. The system of claim 21, wherein the vehicle is a hybrid vehicle comprising an internal combustion engine and an electric motor, and wherein the processor is configured to perform adjustments comprising:
adjusting the amount of assistance provided by the electric motor to operate the vehicle; and
starting or stopping the use of the internal combustion engine based on forecasted usage.

24. The system of claim 21, wherein the processor is further configured to:
identify path conditions that offer opportunities to charge batteries powering the electric motor based on the data related to the condition of the path and adjust the contribution of the electric motor based on the identified opportunities; and
select an alternative path to elongate the distance that can be traveled by the vehicle based on available fuel for the internal combustion engine, power available to the electric motor, and the data related to the condition of the path.

25. The system of claim 21, wherein the processor is configured to adjust the contribution of one or more components of the vehicle configured to set the vehicle in motion based on historic data related to the path stored in the first computer if requested data is not received.
